(19) United States
(12) Patent Application Publication
(10) Pub. No.: US 2012/0158522 A1
(43) Pub. Date: Jun. 21, 2012

(54) RANDOMIZED AUCTIONS WITH PRIORITY OPTION

(75) Inventors: Hamid Nazer Zadeh, Cambridge, MA (US); Lee-Ming Zen, Cambridge, MA (US); Markus M. Möbius, Cambridge, MA (US); L. Elisa Celis, Seattle, WA (US); Gregory M. Lewis, Cambridge, MA (US)

(73) Assignee: Microsoft Corporation, Redmond, WA (US)

(21) Appl. No.: 12/972,382

(22) Filed: Dec. 17, 2010

(51) Int. Cl. G06Q 30/00

(52) U.S. Cl. 705/14.71; 705/26.3

(57) ABSTRACT

Randomized auctions with priority option may be applied in scenarios where a small number of bidders value an item much higher than other bidders. In an auction of an advertising impression, an advertising platform may compute a priority price to be paid by an advertiser who wins a priority auction for the impression. The advertising platform may collect bids from multiple advertisers, and may determine, based on the bids or on election indications from the advertisers, whether to enter any advertisers into the priority auction. In the priority auction, the impression may be allocated to the advertiser with the highest bid, who may be charged at least the priority price. If no advertisers enter the priority auction, the impression may be allocated randomly between the advertisers with the top d bids, and the advertiser winning the randomized secondary auction may be charged a payment amount equal to the (d+1)-th bid.

### BACKGROUND

Many websites derive funding through selling advertising spaces to advertisers. When displayed on the website to a user, the advertising spaces are typically filled with advertisements that are related to content displayed on the website, and/or to input the user has entered into the website. For instance, when a user enters the keyword “car” into a search engine website, an advertising space on the website could be filled with an advertisement for a particular brand of car and displayed to the user along with results of the search. In another example, the same advertisement could be placed in an advertising space on a news website near an article about road travel. The advertisement is provided by an advertiser, such as a manufacturer of that brand of car, who pays to have the advertising space allocated to that advertisement for that displayed content or that keyword occurrence. If the user clicks on the displayed advertisement, the user is connected to the advertiser's website, at which the user can decide to purchase the advertised car.

Advertising spaces on websites, such as sponsored search sites, are typically allocated to particular advertisers in an auction process. In a sponsored search arrangement in which advertisers pay the website owner whenever they receive an allocation (i.e., whenever their advertisements are placed on the website), each advertiser places a bid on an available advertising space for a desired user input, such as a keyword, and the bids are ranked from highest to lowest. Then when a user enters the keyword into the website, the advertising space is allocated to the advertiser with the highest bid. To incentivize advertisers to place bids that reflect their truthful valuation of the advertising space, the payment amount charged to the winning advertiser is typically not the actual amount bid by that advertiser, but rather the next highest amount bid by another advertiser. The auction process is typically highly automated and repeated for every user interaction with the website, such that the website takes advertiser bids and re-allocates the advertising space each time it receives appropriate input from a user. Each allocation of an advertisement to an advertising space is known as an impression.

An advertiser who wins an auction for an advertising impression can pay an owner of the advertising space through various payment arrangements, depending on the terms of the owner's agreement with the advertiser. In a cost-per-impression (CPI) arrangement, as described above, the advertiser makes a payment each time the advertiser is awarded an impression (i.e., an allocation of an advertising space) at auction. Thus, the advertiser's bid is generally the amount the advertiser agrees to pay for a single impression. In a cost-per-click (CPC) arrangement, the advertiser only makes a payment if the advertiser wins the allocation and the user clicks on the advertisement. In this case, the advertiser generally places a standing bid equal to the amount the advertiser is willing to pay for a single click on the advertisement, even though the advertiser may be awarded multiple impressions before one of the impressions results in a click. To allocate each individual impression in a CPC arrangement, advertising platforms often mathematically convert advertisers' CPC bids into equivalent CPI bids (i.e., the estimated amount that the advertiser would have bid in a cost-per-impression arrangement, based on his cost-per-click bid). The platform then ranks those equivalent bids and awards the impression to the advertiser with the highest equivalent bid. In such cases, where an advertiser's per-click bid is converted to an equivalent per-impression bid, the per-impression bid can be considered an estimate of the value that the advertiser places on a single impression. The per-impression bid resulting from conversion of the advertiser's per-click bid can also be considered an estimate of the expected value to the advertising platform of allocating a single impression to that advertiser.

An auction in which the bidder with the highest bid wins the allocation and is charged a payment amount equal to the second-highest bid is known as a second-price auction (SPA). In many cases, the entity running the auction decides on a reserve price, representing the lowest price for which the entity is willing to grant an allocation. In a typical SPA with a reserve price, the winner of the auction pays either the amount of the second-highest bid or the reserve price, whichever is higher, provided that the winner's bid is greater than or equal to the reserve price. If no participant bids an amount greater than or equal to the reserve price, then there is no winner, and no allocation.

SPAs can be implemented to allocate and sell a wide variety of other goods (also referred to herein as products) and services, in addition to online advertising impressions. For example, a number of Internet auction sites allow a seller to list an item (i.e., a product or service) he/she would like to sell, and the auction site conducts a SPA to determine a buyer and a price for the item. Typically, the auction is won by the highest bidder, who pays the seller the amount of the second-highest bid, or the larger of the second-highest bid and the reserve price.

Some Internet auction sites allow sellers to list their items with a “buy-now” price. If any bidder chooses the “buy-now” option, that bidder wins the auction and pays the “buy-now” price. If no bidders choose the “buy-now” option, a normal auction is used to determine a winner (e.g., the highest bidder) and a payment amount (e.g., the amount of the second-highest bid).

### SUMMARY

The inventors have recognized and appreciated that the second-price auction (SPA) formulation may not suitably align incentives between seller and bidders in situations in which a small number of bidders value the item being auctioned much higher than the rest of the bidders. Some embodiments of the present invention address such shortcomings through a novel randomized auction with priority option formulation. To allow a seller to benefit from the truthful valuations of the small number of high bidders, the seller may in some embodiments allow high bidders to enter a priority auction for the item being sold, and may set a priority price as the minimum price that any winner of the priority auction will pay for the item. To incentivize bidders with high valuations to elect the priority option, in some embodiments the seller may also determine a number d of bidders between which the allocation will be randomized if no bidders elect the priority option. Thus, in some embodiments, if no bidders elect to participate in the priority auction, a randomized auction may be held in which the item may be allocated randomly to one of the bidders with the top d bids. The risk of losing the allocation by chance to another bidder in the randomized auction may incentivize a bidder with a high valuation to elect the priority option, in which the highest bidder may be guaranteed the allocation by paying at least the priority price. In some embodiments, a bidder may elect the priority option by submitting a separate indication that he would like to participate in the priority auction, as well as submitting a bid. In other embodiments, bidders may automatically be entered into the priority auction if their respective bids meet or exceed a threshold value.

In some embodiments, the seller may determine the priority price to set for the priority auction, as well as the number d of top bidders among which to randomly allocate in the secondary randomized auction, based on distributions of past bids for similar items at auction. In some embodiments, past bids may be tracked and aggregated into separate distributions for high bids and low bids, and the priority price p and the number d for a current auction may be determined based on the historical distributions. In some embodiments, p may be computed, based on historical distributions of bids, to optimize revenue without discouraging bidders with high valuations from electing the priority option. In some embodiments, the seller may also determine a threshold value t, such that bidders with bids equal to or greater than t may be automatically entered into the priority auction. In some embodiments, the threshold value t may also be computed based on historical distributions of bids, in such a way as to divide the range of potential bids into a high range at which bidders would likely prefer the priority auction, and a low range at which bidders would likely prefer the randomized secondary auction.

Thus, in some embodiments, a seller of one or more products and/or services may establish a priority price as a minimum price to be paid for winning a priority auction for the product(s) and/or service(s). The seller may operate apparatus including one or more network interfaces and one or more processors (e.g., microprocessors) executing instructions to conduct a randomized auction with priority option. In some embodiments, the processor(s) may use the network interface(s) to collect a bid for the product(s) and/or service(s) for each of multiple bidders, as well as an election indication as to whether each bidder elects to participate in the priority auction. In other embodiments, no separate election indication may be given, and the processor(s) may compare one or more of the collected bids to a threshold value to determine whether to automatically enter any of the bidders in the priority auction. If any of the bids meet or exceed the threshold value, or if any of the bidders separately elect the priority option, those bidders may be entered into a priority auction, in which the processor(s) may conduct a SPA to select a winner from among only those bidders. If none of the bidders elect the priority option, or if none of the bids meet or exceed the threshold value, then the processor(s) may perform operations to randomly select a winner from among the bidders with the top d bids. In some embodiments, the processor(s) may further operate to charge the randomly selected bidder a payment amount equal to the (d+1)-th bid. In some other embodiments, the processor(s) may compute a reserve price for the randomized secondary auction, and may charge the maximum of the reserve price and the (d+1)-th bid.

Some further embodiments are directed to methods and apparatus for allocating online advertising impressions. In some embodiments, a computer or other processor(s) (e.g., a microprocessor) may be used to collect a bid for an advertising impression for each of multiple advertisers, and to determine whether to enter any of the advertisers in a priority auction for the advertising impression. If none of the advertisers elect the priority option, or alternatively if all of the bids are below a computed threshold value, the computer/processor(s) may perform a computation to randomly select a winner from among the advertisers with the top d bids, and may allocate the advertising impression to the selected advertiser. In some embodiments, if one or more of the advertisers elect the priority option, or alternatively if one or more of the bids are greater than or equal to the threshold value, the computer/processor(s) may conduct a SPA priority auction among those advertisers to select a winner and allocate the advertising impression.

Further embodiments in accordance with the present invention are directed to computer-readable storage media (e.g., tangible, non-transitory computer-readable media) encoded with computer- and/or processor-executable instructions that, when executed by one or more computers and/or other processors, perform any of the functions described herein.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram illustrating an exemplary webpage including an advertising space that may be allocated in accordance with some embodiments of the present invention;

FIG. 2 is a block diagram illustrating an exemplary system for allocating advertising impressions in accordance with some embodiments of the present invention;

FIG. 3 is a block diagram illustrating operation of an exemplary system for allocating advertising impressions in accordance with some embodiments of the present invention;

FIG. 4 is a flow chart illustrating an exemplary method for conducting a randomized auction with a priority option in accordance with some embodiments of the present invention;

FIGS. 5A and 5B, when connected at the points labeled “A” and “B”, are a flow chart illustrating a detailed exemplary method for allocating advertising impressions through randomized auction with priority option in accordance with some embodiments of the present invention; and

FIG. 6 is a block diagram illustrating an exemplary computing system for use in practicing some embodiments of the present invention.

### DETAILED DESCRIPTION

The inventors have recognized and appreciated that the conventional second-price auction (SPA) formulation can encounter problems when the distribution of bidders' truthful valuations is irregular. In particular, when one bidder values the item being auctioned much higher than the rest of the bidders, the usual SPA may not successfully align the incentives of the bidder and the seller to settle on a fair price for the item. For example, a painting by an obscure artist may be worth much more to the one devoted fan of the artist's work than it is to all the rest of the bidders in the auction, who may not attach any particular significance to the painting. Assume, for instance, that the devoted fan bids $10,000 for the painting; the second-highest bidder bids $1,000; the third-highest bidder bids $950, and so on. When the devoted fan wins the SPA for the painting, she will pay the artist only the amount of the second-highest bid ($1,000), even though she (and no one else) would have been willing to pay much more than that (e.g., ten times more than the second-highest bidder). The SPA formulation incentives bidders to bid truthfully (e.g., the devoted fan has nothing to lose by bidding her truthful valuation of $10,000, as in any case she will only have to pay the amount of the next-highest bid), but does not allow the seller to receive the value placed on the item by the highest bidder.

In such a situation, the struggling artist may easily become frustrated with the SPA formulation, as the price that he earns for his painting is greatly deflated from its true value to the buyer who wins at auction. Such frustration may lead sellers who face such irregular distributions of valuations from bidders to abandon the SPA formulation, perhaps in favor of a first-price auction formulation in which the winning bidder simply pays the amount of her own bid. In a first-price auction, if the devoted fan bids her truthful valuation, she will win the painting and pay the artist $10,000. However, in theory and in practice, first-price auctions generally fail to incentivize bidders to bid truthfully. If the devoted fan knows that the second-highest bid is only $1,000, she will likely place a bid only just high enough to win the auction, such as $1,001, even though she truthfully valued the painting at $10,000. On the other hand, if the auction is conducted such that no bidder is aware of the amount of the other bids (known as a sealed-bid auction), the devoted fan may still have enough information to know that the other bids are likely to be much lower than her truthful valuation of the painting. For example, she may know that she is the artist's best fan, or she may know that the artist is about to become famous for reasons that are not yet public to the other bidders. In this case, she may take a guess at a bid ($2,000, perhaps) that she thinks will be high enough to beat the other bidders, but is still much less than her truthful valuation. In this scenario, the struggling artist still loses value on his sale, and the devoted fan is subjected to a painstaking guessing game that could involve a large amount of research and strategizing to decide on a bid other than her truthful valuation.

If bidders always bid their truthful valuations of items at auction, the “buy-now” option used by some Internet auction sites such as eBay could be effective to prevent some loss of value to the seller. For example, if the struggling artist set a “buy-now”price of $5,000 on his painting, the devoted fan could choose the “buy-now” option, automatically win the painting, and save herself $5,000 from her truthful valuation of the painting. Meanwhile, the struggling artist could make an extra $4,000 (the difference between the “buy-now” price of $5,000 and the second-highest bid of $1,000) over what he would earn in a regular SPA. However, the inventors have recognized and appreciated that, if the devoted fan has any knowledge that would lead her to believe that none of the other bidders will pay the “buy-now” price of $5,000, she will have no incentive to choose the “buy-now” option. By choosing to “wait” instead of paying the “buy-now” price, she can participate in the SPA once no one chooses the “buy-now” option, and again she will pay much less than either her truthful valuation of $10,000 or the “buy-now” price of $5,000.

These and other disadvantages of the conventional SPA, with or without the conventional “buy-now” option, may be addressed and improved upon through some embodiments of the present invention, including a randomized auction with priority option formulation. In some embodiments, a seller of one or more products and/or services may establish a priority price as a minimum price to be paid by the winner of a priority auction for the product(s) and/or service(s). The seller may operate apparatus including one or more network interfaces and one or more processors (e.g., microprocessors) executing instructions to conduct a randomized auction with priority option. The processor(s) may use the network interface(s) to collect a bid for the product(s) and/or service(s) for each of multiple bidders, and may determine whether to enter any of the bidders in the priority auction. In some embodiments, bidders may elect to enter the priority auction by submitting an election indication in addition to their bids. If any bidders elect the priority option, the processor(s) may conduct a SPA to select a winner from among only those bidders. In other embodiments, bidders may automatically be entered in the priority auction if their bids meet or exceed a threshold value computed by the processor(s). If none of the bids meet the threshold value, or alternatively if none of the bidders separately elect the priority option, then the processor(s) may perform operations to randomly select a winner from among the top d bidders. The processor(s) may further operate to charge the randomly selected bidder a payment amount equal to the (d+1)-th bid.

Thus, in some embodiments, if only one bidder enters the priority auction, that bidder may be selected to win the auction and pay the priority price. If two or more bidders enter the priority auction, the winner may be selected through a SPA among only those bidders. If no bidders enter the priority auction, a secondary, randomized auction may be held in which the winner is selected randomly from among the top d bidders, and pays the (d+1)-th price (bid).

In contrast with the conventional SPA and the conventional SPA with “buy-now” option, a randomized auction with priority option in accordance with some embodiments of the present invention may properly incentivize bidders to bid truthful valuations, even when the distribution of valuations is such that one bidder's valuation is much higher than the other bidders' valuations. In the example above of the struggling artist and the devoted fan, the struggling artist may set a priority price of $5,000 for his painting, and may set the number d to be 2. Even if the devoted fan has reason to know that the second-highest bid will only be $1,000, she may not wish to forego the priority option and enter the secondary auction with a bid much lower than her truthful valuation. Because the secondary auction may randomly allocate the painting to either the highest bid or the second-highest bid (e.g., with equal 50% probability), the devoted fan may be taking a 50% chance of losing the painting by not electing the priority option. However, by electing the priority option and paying the priority price of $5,000, the devoted fan may happily be assured of winning the painting, saving $5,000 from her truthful valuation of $10,000, and allowing the struggling artist to maintain more of the value from his sale.

The inventors have recognized and appreciated that situations in which one bidder has a much higher valuation of an item at auction than other bidders can be found quite frequently in the context of online advertising. For example, an advertising space in a banner next to a sports article on a news website may be worth much more to a sportswear advertiser than to the other advertisers bidding on the advertising space. Moreover, some online advertising platforms allow advertisers to bid on impressions to be viewed by particular users, as targeting advertisements to particular users may increase the probability that the user will click on the advertisement and result in revenue to the system. The inventors have recognized, however, that such targeting in the SPA formulation may unfairly advantage advertisers with sophisticated technology for tracking individual user spending habits. For example, advertisers who have the capability to make extensive use of cookies may be able to target particular advertisements to particular users who have shown a pattern of responding profitably to such advertisements when placed near particular web content. Such sophisticated advertisers may value these targeted matches to narrow categories of impressions very highly, such that their truthful bids for matching impressions would be much higher than other advertisers' bids. On the other hand, less sophisticated advertisers without comparable tracking capabilities may tend to have consistently lower valuations spread across many different categories of impressions. Under the conventional SPA formulation, in which a lone high bidder wins the auction but only pays the much lower second-highest bid, the inventors have appreciated that the more sophisticated advertisers may be able to take advantage of the targeting capabilities offered by the advertising platform, predictably winning allocations away from the less sophisticated advertisers without paying anything more for the privilege than the much lower bids of the less sophisticated advertisers.

In such contexts, similar to the generic auction contexts described above, the inventors have recognized and appreciated that conventional auction techniques may not properly align the incentives of the advertisers and the website owners to establish a fair allocation and price for the advertising impression. Fairer allocation and pricing may be accomplished in some embodiments by allocating the advertising impression through randomized auction with priority option.

Accordingly, some embodiments in accordance with the present invention are directed to methods and apparatus for allocating online advertising impressions. In some embodiments, a computer or other processor(s) (e.g., a microprocessor) may be used to collect a bid for an advertising impression for each of multiple advertisers, and to determine whether to enter any of the advertisers in a priority auction for the advertising impression. If none of the advertisers elect the priority option, or alternatively if all of the bids are below a computed threshold value, the computer/processor(s) may perform a computation to randomly select a winner from among the advertisers with the top d bids, and may allocate the advertising impression to the selected advertiser. In some embodiments, if one or more of the advertisers elect the priority option, or alternatively if one or more of the bids are greater than or equal to the threshold value, the computer/processor(s) may conduct a SPA priority auction among those bids to select a winner and allocate the advertising impression.

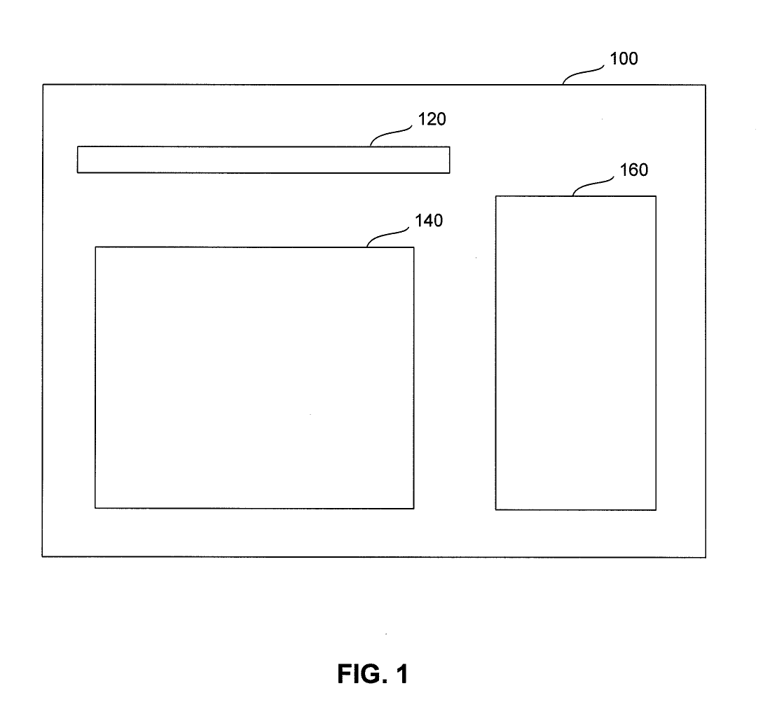

FIG. 1 illustrates an exemplary webpage 100 in which an advertising space 160 may be available for allocation to an advertisement provided by an advertiser, in accordance with some embodiments of the present invention. Webpage 100 may be implemented using known techniques and maintained by a web server, which may be part of an advertising platform or may be implemented by a separate system that interfaces with the advertising platform in any suitable fashion to present webpage 100 with both content and an advertisement. Webpage 100 may be viewed by a user through a web browser application of the user's computing system, using known techniques. Webpage 100 may include one or more fields 120 through which the user may enter input such as text, as well as one or more panels 140 in which content may be displayed to the user. It should be appreciated that webpage 100 may include any number of fields, panels and/or other known webpage components in addition to advertising space 160, and may also include multiple advertising spaces, as aspects of the present invention are not limited in this respect.

In some embodiments, content may be served up by the web server for display to the user in content panel 140, in response to user input entered through field 120. For example, webpage 100 may be a portal to an Internet search engine, and input field 120 may be a text entry field in which a user may input one or more keywords and/or keyword strings for search. In response to the user input, a search engine of the web server may acquire and display appropriate content including search results in content panel 140. In another example, webpage 100 may be a page of another type of website, such as an e-mail application website, and input field 120 may be a field in which a user may input text such as e-mail messages. In other examples, user input may entered in non-textual forms, such as by mouse clicks on selectable text or graphics displayed in content panel 140 or in other areas of webpage 100. For example, one type of user input may be selection of a hyperlink leading to a page on which a particular type of content is displayed. It should be appreciated that webpage 100 may be any type or form of webpage that includes one or more advertising spaces 160, and webpage 100 may be configured to allow its web server to receive user input in any appropriate form, as aspects of the present invention are not limited in this respect.

In some embodiments, the web server/advertising platform maintaining webpage 100 may fill advertising space 160 with particular advertisements tailored to interests of the user that it has identified. Such tailoring may increase the likelihood that the user will be interested enough to select the advertisement, for example by clicking on it with a mouse. For example, when the user enters text into input field 120 that contains a particular keyword and/or keyword string, a processor of the advertising platform may automatically identify and select an advertisement for advertising space 160 that has been provided by an advertiser who placed a bid for that advertising space and keyword/keyword string. In some embodiments, the advertising platform's processor may also be programmed to map user input to a closest keyword for which an advertiser has placed a bid, even if the user input does not explicitly contain that keyword. Other forms of user input, for example selections of selectable icons, graphics and/or displayed text, may also be mappable to advertising bids, using any suitable means. For example, when the user selects a hyperlink to a page with particular content, that content may be matched to an appropriate advertisement. It should be appreciated that an advertising platform may identify an appropriate set of advertisements (corresponding to an appropriate pool of advertiser bidders) in response to receiving any suitable form of user input in any suitable way, as aspects of the present invention are not limited in this respect.

Each time user input received by an advertising platform is mapped to a particular keyword or other association for which advertisers have bid for advertisement placement, one or more associated advertising spaces 160 may become available for allocation. When an advertising platform receives appropriate user input and allocates the advertising space 160 to an advertiser, displaying that advertiser's advertisement to the user in advertising space 160 in response to the user input, that allocation process is referred to herein as an impression. Large numbers of impressions may take place for an advertising space in very short time frames, especially when multiple users worldwide may concurrently view the same webpage 100 and enter user input associated with the same advertising space 160.

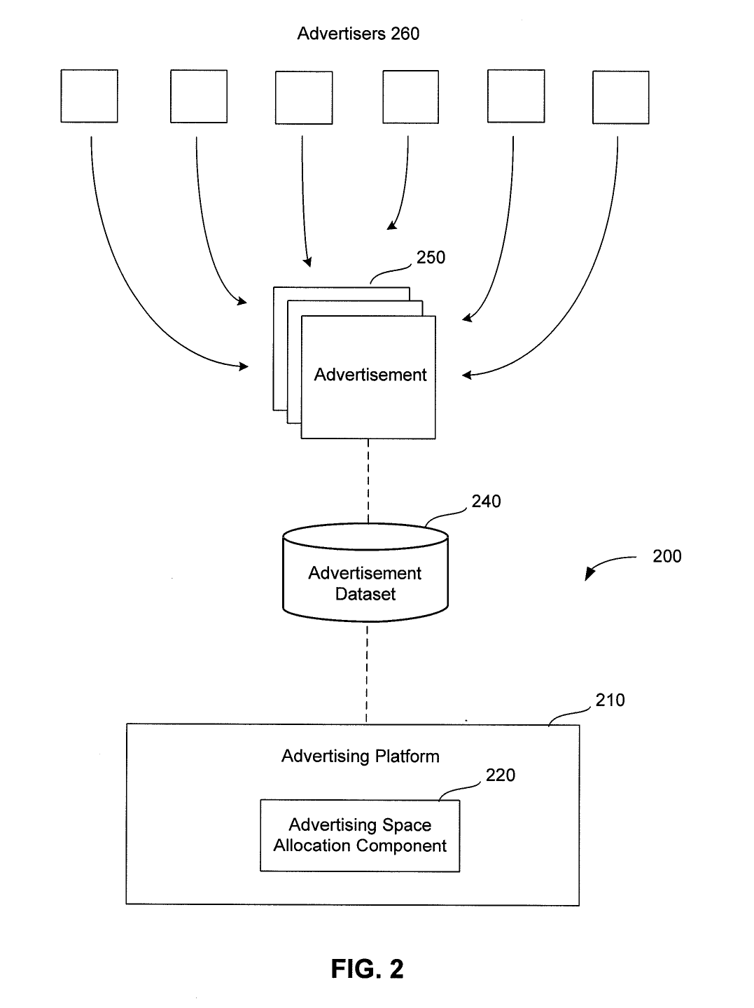

FIG. 2 illustrates an exemplary system 200 for allocating advertising impressions in accordance with some embodiments of the present invention. System 200 may include an advertisement dataset 240 that stores a number of advertisements 250, each advertisement having been provided by one of multiple advertisers 260. Advertisement dataset 240 may be implemented in any suitable form including any of various forms known in the art, for example as one or more computer-readable storage media encoded with data representing advertisements 250. Advertisement dataset 240 may be operatively connected to an advertising platform 210 using any suitable means, including wired and/or wireless connections. Alternatively, advertisement dataset 240 may be accessible to advertising platform 210 through a network such as a local-area network, medium-area network or wide-area network such as the Internet. Similarly, advertisers 260 may supply advertisements 250 in electronic form to advertisement dataset 240 through any suitable form of physical or network connection.

Advertising platform 210 may be implemented as one or more computer systems, including one or more processors programmed to perform aspects of the present invention described herein. Program code instructions executable by the one or more processors may include instructions to implement an advertising space allocation component 220. Computer-executable instructions implementing advertising space allocation component 220 may be encoded in one or more tangible, non-transitory computer-readable storage media operatively connected to advertising platform 210 and its one or more processors. The computer-executable instructions, when executed by the one or more processors of advertising platform 210, may implement functions of advertising space allocation component 220 to allocate available advertising spaces to advertisements 250 provided by advertisers 260. Advertising space allocation component 220 may also include any suitable hardware components of advertising platform 210 configured to implement aspects of the present invention described herein.

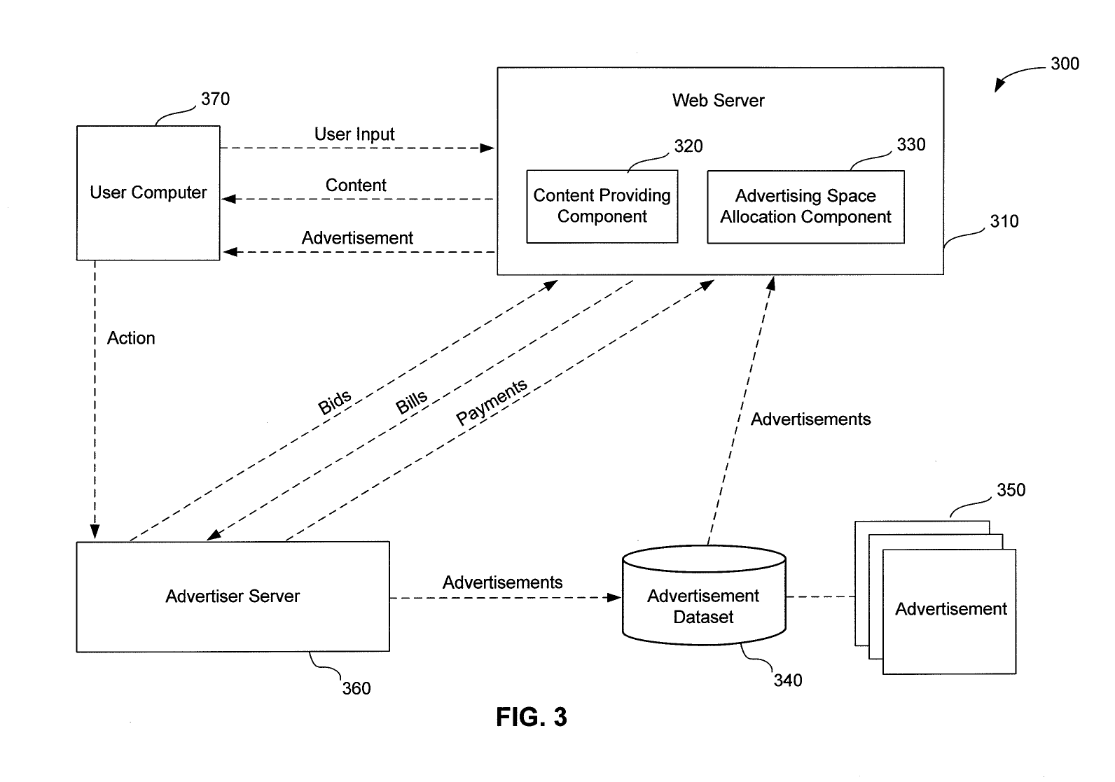

FIG. 3 illustrates operation of an exemplary system 300 for allocating an advertising impression to an advertiser, in accordance with some embodiments of the present invention. Although interactions are illustrated with respect to only one advertiser in FIG. 3, it should be appreciated that such interactions may be generalized to any number of advertisers, as illustrated previously in FIG. 2. It should be appreciated that any number of advertisers may participate in an auction for allocation of an advertising impression, in accordance with some embodiments of the present invention, as aspects of the present invention are not limited in this respect.

FIG. 3 illustrates a web server 310, representing an exemplary component of an advertising platform. Web server 310 may be implemented as one or more computer systems, including one or more processors configured to perform aspects of the present invention described herein. Web server 310 may include a content providing component 320 and an advertising space allocation component 330. Content providing component 320 and advertising space allocation component 330 may each be implemented as program code embodied on one or more tangible, non-transitory computer-readable storage media, including computer-executable instructions that can be executed by the one or more processors of web server 310.

A user computer 370, which may be implemented in any of various forms as known in the art, may communicate with web server 310 through any suitable network connection(s), examples of which are provided herein. In response to receiving user input from a user of computer 370, web server 310 may, through execution of functions of content providing component 320, transmit appropriate content to user computer 370 for display as part of a webpage. Web server 310 may also, through execution of functions of advertising space allocation component 330, select an advertisement 350 to which to allocate an advertising space of the webpage, and transmit the selected advertisement in the advertising space of the webpage to user computer 370.

Web server 310 may obtain advertisements 350 to be selected by allocation component 330 from an advertisement dataset 340. Web server 310 may have access to advertisement dataset 340 through any suitable local or network connection(s), examples of which are provided herein. Advertisement dataset 340 may also be accessible through any suitable network connection(s) to advertiser server 360, which may provide one or more advertisements to be stored in advertisement dataset 340. Advertisements 350 may be stored in advertisement dataset 340 through any suitable technique(s) and in any suitable form(s), as aspects of the present invention are not limited in this respect.

Advertiser server 360 may be owned and/or operated by a representative advertiser, and may communicate with the advertising platform associated with web server 310 to participate in one or more auctions for one or more impressions of one or more advertising spaces. Although only one advertiser server 360 is illustrated in FIG. 3, it should be appreciated that web server 310 may interact with any number of advertiser servers corresponding to different advertisers participating in one or more advertising impression auctions with the advertising platform corresponding to web server 310.

Advertiser server 360 may be implemented as one or more computer systems, including one or more processors configured to perform aspects of the present invention described herein. Advertiser server 360 may include one or more tangible, non-transitory computer-readable storage media encoded with computer-executable instructions that, when executed by the one or more processors of advertiser server 360, perform various processes as described herein. Advertiser server 360 may communicate with web server 310 and with user computer 370 through any suitable network connection(s), examples of which are provided herein.

The one or more processors of advertiser server 360 may be programmed to perform various functions to participate in a randomized auction with priority option into which the corresponding advertiser may enter for one or more impressions of an advertising space managed by web server 310. In some embodiments, advertiser server 360 may, through operations performed by its one or more processors, compute a bid report for the advertising space and transmit the bid report to web server 310 to participate in the auction. The bid report may be computed to reflect the perceived value to the advertiser of having the advertiser's advertisement allocated to the advertising space (e.g., in a cost-per-impression (CPI) arrangement), the perceived value of a user clicking on the advertisement if it is allocated to the advertising space (e.g., in a cost-per-click (CPC) arrangement), the perceived value of another desired user action that may result from the advertisement being allocated to the advertising space (e.g., in a cost-per-action (CPA) arrangement), or any other criteria that advertiser server 360 may be programmed to compute. In some embodiments, computing systems of all advertisers participating in the auction may be programmed to compute bid reports according to similar metrics, in compliance with communication and/or payment rules of the auction. However, in some embodiments advertisers may be free to compute their respective bid reports in any suitable way using any suitable metric, including metrics that are specific and/or proprietary to individual advertisers.

In response to receiving the bid report from advertiser server 360, in some embodiments the one or more processors of web server 310 may, through execution of program code included in allocation component 330, compute a ranking for advertiser server 360 and/or its corresponding advertiser. In some embodiments, allocation component 330 may compute this ranking simply by ordering the unaltered bids from the bid reports from multiple advertisers participating in the auction from highest to lowest. For example, if the auction is structured with a CPI payment arrangement, each advertiser's bid as received in the bid report may equal the amount that advertiser will pay for a single impression, such that the advertiser's bid equals the expected revenue that the website owner will collect from allocating the impression to that advertiser. In such an arrangement, allocation component 330 may have no reason to alter or convert the advertisers' bids in any way prior to ranking them. However, it should be appreciated that allocation component 330 may be programmed to perform any suitable mathematical operations on advertiser bids as may be appropriate for the economic arrangement of the auction, as aspects of the present invention are not limited in this respect. Such operations may convert an advertiser's bid to a corresponding equivalent bid that may be preferable for ranking the advertisers for any suitable reason of interest to the website owner. It should be appreciated that the term “bid”, as used herein, may include unaltered original bids as well as mathematical conversions of original bids to values used to select one or more entities or differentiate one or more entities from others participating in the auction. Such mathematical conversions may include, for example, weighting, scaling or adding an offset.

In some embodiments, a bid received from advertiser server 360 may be mathematically converted by allocation component 330 to an equivalent bid for the single impression being currently auctioned. For example, in a CPC arrangement, in which the bid received from advertiser server 360 is the amount that the advertiser would like to pay per click, allocation component 330 may multiply the advertiser's per-click bid by the click-through rate for the advertisement corresponding to the bid. The resulting equivalent per-impression bid may estimate the value to the advertising platform of allocating a single impression to that advertisement. In some embodiments, the per-impression bid may also correspond to the estimated value that the advertiser places on a single impression for that advertisement. Similarly, in a CPA arrangement, allocation component 330 may in some embodiments multiply the advertiser's bid by the click-through rate as well as the action rate for the advertisement, to convert the per-action bid to an equivalent per-impression bid.

It should be appreciated, however, that advertiser bids may be converted for further processing using any suitable criteria and/or computations, as aspects of the present invention are not limited in this respect. While such converted bids may in some embodiments be equivalent to an estimated value placed on a single impression by an advertising space owner and/or by an advertiser placing the original bid, it should be appreciated that converted bids may have any suitable relation to their corresponding original bids, including an identity relation (e.g., the bids ranked by allocation component 330 may in some embodiments be equal to the bids in the advertisers' bid reports themselves). In addition, it should be appreciated that not all advertisers' bids need be converted in the same way, and that not all advertisers need participate in the auction under the same payment arrangement, as aspects of the present invention are not limited in this respect. In one example, one advertiser participating in an auction may place a per-impression bid while another advertiser participating in the same auction may place a per-click bid, and the per-click bid may be mathematically converted to an equivalent per-impression bid before ranking, while the per-impression bid may be ranked without alteration or conversion. It should be appreciated that the term “bid”, as used herein, is intended to encompass all such original bid reports and mathematically converted bids as may be used in further processing for conducting auctions.

In some embodiments, allocation component 330 may collect bids (e.g., by receiving bid reports and then converting the original bids, through mathematical computations that may include the identity relation, to corresponding equivalent bids) from all advertisers participating in the auction before ranking the bids from highest to lowest. In other embodiments, however, allocation component 330 may initiate and maintain a ranking of bids before they have been received from all participating advertisers. For example, allocation component 330 may receive bids from different advertisers individually, and may re-rank the bids it has collected each time a new bid report is received from a participating advertiser. In other examples, allocation component 330 may re-rank the collected bids each time a batch of a certain number of new bid reports has been received, or at regular intervals of time independent of the number of new bid reports received. In some embodiments, advertisers may be required to place new bids for each new auction of a single impression, while in other embodiments, one or more advertisers may have the capability to place a standing bid that applies to multiple successive auctions of an advertising space. For example, in some embodiments advertiser server 360 may transmit a standing bid to web server 310 prior to one impression auction, and may not transmit any other bid report for multiple successive impression auctions. Allocation component 330 may treat this standing bid as if it had been resubmitted for each auction. If at any time advertiser server 360 updates the standing bid by transmitting a new bid amount, allocation component 330 may treat the updated amount as a new bid, and may re-rank the collected bids from all advertisers accordingly. It should be appreciated that bids may be placed by advertisers, and may be converted to equivalent bids for ranking, in any suitable way and/or form, as aspects of the present invention are not limited in this respect.

In some embodiments, allocation component 330 may rank all of the bids collected for advertisers participating in the auction from highest to lowest, for use in determining a winner for the auction. However, in some embodiments, allocation component 330 may not retain ranking information for all of the advertisers, but may instead retain and consider only the ranking information for the highest bid or the highest few bids. For example, in some embodiments, as allocation component 330 collects bids for advertisers, it may compare each newly received or computed bid with the highest previously received or computed bid, and may retain only the information of which bid is currently highest. In some embodiments, allocation component 330 may rank only a certain number of advertisers with the highest bids, and may not retain or compute rankings for advertisers with bids lower than the lowest bid in the ranked group. In some embodiments, if one or more advertisers' bids meet or exceed the threshold value for entering a given priority auction, allocation component 330 may retain only enough ranking information to identify the advertiser with the highest bid and the advertiser with the second-highest bid meeting or exceeding the threshold value, for use in the priority auction. Similarly, in some embodiments in which one or more advertisers separately elect whether to participate in the priority auction, allocation component 330 may retain ranking information only for those advertisers who elected the priority option. If no advertisers elect the priority option, or alternatively if no advertisers' bids meet or exceed the threshold value, in some embodiments allocation component 330 may retain only enough ranking information to identify the advertisers with the top d+1 bids, for use in the secondary auction. However, it should be appreciated that allocation component 330 may rank advertisers and their respective bids in any suitable way, and may rank any suitable number or subset of advertisers and/or bids, as aspects of the present invention are not limited in this respect.

In some embodiments, allocation component 330 may make a determination, for a given impression auction, as to whether any of the participating advertisers are to be entered into a priority auction. In some embodiments, the determination may be made based on separate election indications given by one or more of the advertisers in addition to their bids. For example, in some embodiments, any advertiser wishing to participate in the priority auction may transmit to web server 310 an express indication, in addition to the advertiser's bid, of the advertiser's election of the priority option. In some embodiments, any advertiser who does not expressly elect the priority option may not be entered in the priority auction. However, in other embodiments, any advertiser who does not wish to participate in the priority auction may transmit an express indication of non-election of the priority option, and any advertiser who does not submit such a non-election indication may be entered in the priority option. In still other embodiments, each advertiser may submit an election indication as to whether the advertiser does or does not elect the priority option. It should be appreciated that election indications may be received by web server 310 in any suitable form and in any suitable way, as aspects of the present invention are not limited in this respect. Further, it should be appreciated that in some embodiments advertisers may be free to submit any election indication desired, regardless of the relationship between the advertiser's bid and the priority price for the priority auction. An advertiser with a bid higher than the priority price may nevertheless wish not to participate in the priority auction, and may have his bid entered in the secondary randomized auction should no other advertiser elect the priority option. Similarly, an advertiser with a bid lower than the priority price may nevertheless elect the priority option, entering the priority auction where he will have to pay the priority price if he wins the impression.

In other embodiments, allocation component 330 may determine whether to enter any advertisers into a priority auction based on whether any bids collected for participating advertisers meet or exceed a threshold value for entering the priority auction. In some embodiments, allocation component 330 may compare each bid to the threshold value as the bid is collected. In some embodiments, once a bid is collected that meets or exceeds the threshold value, the impression may be immediately awarded to the advertiser corresponding to that bid, and the auction may be ended. This may be done without further ranking or computing of bids or receiving of bid reports. In other embodiments, allocation component 330 may collect bids for all participating advertisers, determine whether any of the collected bids meet or exceed the threshold value (e.g., by comparing one, some or all of the collected bids to the threshold value), and enter any of the advertisers whose bids meet or exceed the threshold value into the priority auction. In some embodiments, the winner of the priority auction (e.g., the advertiser in the priority auction with the highest bid) may receive the impression and pay the priority price or the amount of the second-highest bid, whichever is larger. However, in other embodiments, the winner of the priority auction may only pay the priority price, regardless of the amount of the second-highest bid. In some embodiments, if two or more advertisers tie with the highest bid, the impression may be randomly allocated between the tied advertisers.

The priority price and the threshold value (in embodiments in which a threshold value is used to automatically enter advertisers into the priority auction) may have any suitable relation, as aspects of the present invention are not limited in this respect. In some embodiments, the threshold value may be computed to be higher than the priority price, such that advertisers with bids higher than the priority price but lower than the threshold value may not be entered in the priority auction. This may allow for advertisers with bids just slightly higher than the priority price to take a chance at winning the allocation in the secondary randomized auction and paying only the amount of the (d+1)-th bid. However, in other embodiments, the threshold value for automatic entry into the priority auction may be equal to the priority price itself. In still other embodiments, the threshold value may even be computed to be lower than the priority price, For example, this may come about in embodiments in which any advertiser who enters the priority auction immediately wins the allocation and ends the auction. In some cases, the threshold value may be computed to be lower than the priority price, such that an advertiser with a bid only slightly lower than the priority price may be allowed to automatically and immediately win the auction by paying the priority price slightly higher than his own bid.

In some embodiments, the priority price and/or the threshold value may be computed based on a distribution of historical bids collected for advertisers in past advertising impression auctions. The advertising platform represented by web server 310 may in some embodiments store data representing previous bids that have been collected by the platform for previous impressions of the same advertising space currently being auctioned, and/or of different advertising spaces or other products and/or services. In some embodiments, the advertising platform may compute the priority price and/or the threshold value for the current auction based on a historical distribution of bids for only the advertising space currently being auctioned, or for a set of similar advertising spaces. In other embodiments, however, the priority price and/or the threshold value may be computed based on a distribution of historical bids for varied advertising spaces and/or other products and/or services that have been aggregated and normalized.

In some embodiments, the advertising platform may aggregate the historical bid data into two different distributions, one for high bids (F_{H}) and one for low bids (F_{L}). Individual historical bids may be assigned to one of the two distributions such that the supports for the distributions are disjoint, and the highest bid in the low distribution is lower than the lowest bid in the high distribution. In some embodiments, the advertising platform may compute the priority price for the current auction to be slightly less than the average of the high bid distribution F_{H}. If the distribution represents normalized historical data for varied products, the advertising platform may un-normalize the computed value to arrive at a priority price that fits the range of the distribution for the advertising space currently being auctioned. In some embodiments, the priority price may be announced to the advertisers prior to receiving bid reports. However, in other embodiments, while advertisers may be aware of the randomized auction with priority option formulation, the amount of the priority price may be kept privately by the advertising platform. In some embodiments, an advertiser may enter the priority auction simply by indicating an election of the priority option, without providing a specific bid. The advertising platform may then treat the advertiser's bid as equal to the priority price, whether or not the priority price is publicly announced.

In some embodiments, if no advertisers participating in the current auction separately elect the priority option, or alternatively if no bids collected for participating advertisers meet or exceed the threshold value, a winner for the auction may be determined through a secondary randomized auction. In some embodiments, allocation component 330 may randomly select a winner from among the advertisers with the top d bids. In some embodiments, allocation component 330 may perform this random selection using a uniform randomization algorithm, in which each of the advertisers with the top d bids is equally likely to receive the allocation. However, in other embodiments, allocation component 330 may use a different randomization algorithm, such as, for example, one in which the advertiser with the highest bid is more likely to receive the allocation than another advertiser within the top d bids, or one in which the advertiser with the highest bid is less likely to receive the allocation than another advertiser within the top d bids. It should be appreciated that the randomization of the allocation between the advertisers with the top d bids may be performed in any suitable way, as aspects of the present invention are not limited in this respect.

In some embodiments, the advertising platform may compute the number d also based on the historical distributions F_{L} and F_{H}. In some embodiments, the advertising platform may compute d based on the distance between the two distributions, such that, for a fixed priority price p, a larger d is computed if F_{L} and F_{H} are closer together, and a smaller d is computed if F_{L} and F_{H} are farther apart. For example, if the highest historical bid in F_{L} is w_{L} and the lowest historical bid in F_{H} is w_{H}, in some embodiments the number d may be computed to vary inversely with w_{H}-w_{L}, for fixed p. Thus, in some embodiments, if the separation between the typical high bids and the typical low bids is large, the number of bidders among whom the allocation is randomized in the secondary auction may be increased. A bidder with a much higher bid than other bidders may thus in some embodiments be properly incentivized to elect the priority option, as the chance of allocation in the secondary auction may be spread among a larger number of bidders. However, in some embodiments, both p and d may be allowed to vary and may be determined together based on the shape and spread of distributions F_{L} and F_{H}, and an increase in separation between the distributions may cause both p and d to increase.

In some embodiments, when the secondary auction is held, the winner of the randomized auction may receive the advertising impression and pay the amount of the (d+1)-th highest bid. If there is a tie in which multiple advertisers have the d-th highest bid, in some embodiments all of the advertisers with that bid may split a 1/d probability of winning the impression, and the winner of the impression may pay the amount of the d-th highest bid. In some embodiments, however, the advertising platform may compute a reserve price r for the secondary auction, and the winner of the impression may pay the maximum of the reserve price r and the (d+1)-th bid. In some embodiments with a reserve price r, if fewer than d advertisers have bids that meet or exceed r, then the winner may be selected randomly from among only those advertisers whose bids meet or exceed r. In some embodiments, the advertising platform may compute r based on the historical low bid distribution F_{L}.

In some exemplary embodiments, the priority price p, the threshold value t (if any), the number d and the reserve price r (if any) may be computed by solving the following mathematical equations. These values may be computed, for example, by the one or more processors of web server 310 executing the program code of allocation component 330, or by one or more other components of the advertising platform.

Assume that F_{L} and F_{H} together form a mixture distribution F of the random variable V=(1−X)V_{L}+XV_{H}, where X is a Bernoulli random variable with P(X=1)=α. Let H be the total number of advertisers with high bids.

The reserve price r may be computed by:

$$r = \frac{( 1 - F ( r ) )}{f ( r )}$$

where f is the density of the distribution F.

The threshold value t, the priority price p, and the number d of advertisers between which to randomize allocation in the secondary auction may be computed by solving the following equations:

$$t = p + \frac{1}{d} E [ t - {Y}^{*} \vert {Y}^{1} < t ]$$

$$p ( d , r ) = {R}_{1} ( d , r ) + ( \frac{d - 1}{d} ) \frac{1 - F ( t ( p , d , r ) )}{f ( t ( p , d , r ) )}$$

if a solution exists with t within the support of F_{H}. Otherwise:

$$p ( d , r ) = \frac{d - 1}{d} {w}_{H} + \frac{1}{d} E [ {Y}^{*} \vert {Y}^{1} < {w}_{H} ]$$

In these equations, Y¹ denotes the highest rival bid; Y* represents the maximum of the d-th highest rival bid and the reserve price r; R₁ represents the expected revenue from the secondary auction when all advertisers participate, but only one advertiser has a high bid; and W_{H} represents the lowest historical bid in F_{H}. In this formulation, p may represent the expected revenue from the randomized secondary auction (the “outside option”) plus a markup term.

Each time web server 310 receives user input that can be appropriately mapped to an advertising impression, the corresponding advertising space may become available for allocation in a randomized auction with priority option. If, in the ensuing auction, the impression is allocated to an advertisement provided by advertiser server 360, web server 310 may transmit that advertisement in the advertising space to user computer 370. The advertisement in the advertising space may be selectable by the user of computer 370, and, if the user selects the advertisement, the user's network connection may be transferred to advertiser server 360, through which the user may have the opportunity to perform an action of value to the advertiser. In some embodiments, such a valuable action may include purchasing a product advertised in the advertisement selected by the user. In other embodiments, such an action may include signing up for a service, joining a mailing list, providing information, or any of numerous other suitable actions, as aspects of the present invention are not limited in this respect. Each time an advertisement is transmitted to a user in an allocated advertising space, web server 310 may learn and update stored statistical data pertaining to the click-through rate of that advertisement. Each time a user selects an advertisement in an allocated advertising space and visits advertiser server 360, advertiser server 360 may learn and update stored statistical data pertaining to the action rate per click for that advertisement.

When allocation component 330 of web server 310 allocates an impression to an advertisement provided by advertiser server 360, web server 310 may compute a payment amount to charge to advertiser server 360. As discussed above, if the advertiser elected the priority option, or alternatively if the advertiser's bid was equal to or greater than the threshold value for the auction, web server 310 may compute the payment amount to be equal to the priority price, or to the second-highest bid that was equal to or greater than the priority price. If the advertiser did not elect the priority option, or alternatively if the advertiser's bid was less than the threshold value, web server 310 may compute the payment amount to be equal to the amount of the (d+1)-th highest bid or the reserve price r, whichever is higher.

Web server 310 and advertiser server 360 may be configured to exchange payment information to transact the advertiser's payment in any suitable way, as aspects of the present invention are not limited in this respect. For instance, in one example, web server 310 may transmit a bill to advertiser server 360 for the payment amount, and advertiser server 360 may transmit payment information allowing web server 310 to transact an electronic transfer of funds in the payment amount to a financial account associated with an owner and/or operator of web server 310. In another example, the advertiser may have a pre-established account from which web server 310 may automatically deduct funds to transact the payment. In some embodiment, payments may be charged to advertiser server 360 each time the advertiser receives an impression. In other embodiments, payments for impression allocations may be aggregated and charged to advertiser server 360 in batches, or at regular time intervals. In various embodiments, advertisers may choose payment options and/or payment options may be assigned to certain advertisers in any suitable way according to any suitable criteria, as aspects of the present invention are not limited in this respect.

In some embodiments, advertiser server 360 may also be programmed to transmit action rate reports to web server 310. Action rate reports may represent private statistical data observed and/or estimated by advertiser server 360, pertaining to rates at which users perform valuable actions on the advertiser's website given that the users select the advertiser's advertisement to which the advertising space was allocated. Such action rates may have been learned by advertiser server 360 over time by observing user behavior, or may be estimated by advertiser server 360 using information known to the advertiser. Allocation component 330 may be programmed to use such action rate reports, when available, in converting advertiser bid reports to equivalent converted bids. In some embodiments, allocation component 330 may also be programmed to consider statistical data such as click-through rates in its computations. Click-through rates may be directly observable by web server 310, and may be updated over time as advertising spaces are allocated in successive impressions, and users are observed to either click on the advertisement or not.

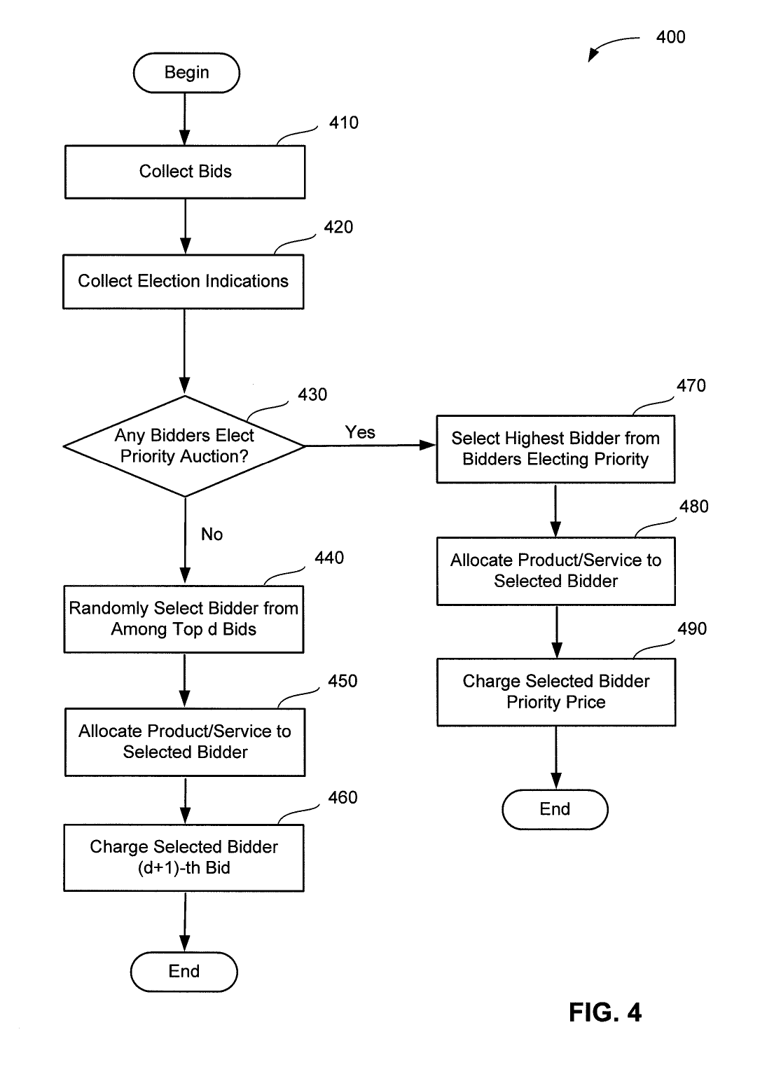

FIG. 4 illustrates an exemplary method 400 for conducting a randomized auction with priority option, in accordance with some embodiments of the present invention. Method 400 begins at act 410, at which a bid for the product and/or service being auctioned may be collected for each bidder. At act 420, election indications may be collected for one or more of the bidders, where a bidder may expressly indicate whether or not to enter the priority auction, independent of the bidder's bid. However, in some alternate embodiments as discussed above, one or more of the collected bids may be compared to a threshold value to determine whether any of the bids meet the threshold and should automatically be entered in the priority auction without an express election to do so.

If it is determined at act 430 that none of the bidders elect to participate in the priority auction, a randomized auction may be conducted. At act 440, a winner of the auction may be selected randomly from among the bidders with the top d bids. At act 450, the product and/or service may be allocated to the selected winning bidder. At act 460, the selected bidder may be charged a payment amount equal to the (d+1)-th bid.

If it is determined at act 430 that one or more of the bidders elect the priority option, those bidders may be entered into a priority auction for the product and/or service. At act 470, the priority auction may be conducted as a SPA between only those bidders who elected the priority option. At act 480, the product and/or service may be allocated to the winner of the priority auction, e.g., the bidder with the highest bid. At act 490, the winning bidder may be charged the payment price for the SPA priority auction, equal to the maximum of the priority price and the second-highest bid. If only one bidder elects the priority option, then that bidder may win the priority auction and pay the priority price. If two or more bidders elect the priority option, then the bidder with the highest bid may win the priority auction and pay the amount of the second-highest bid.

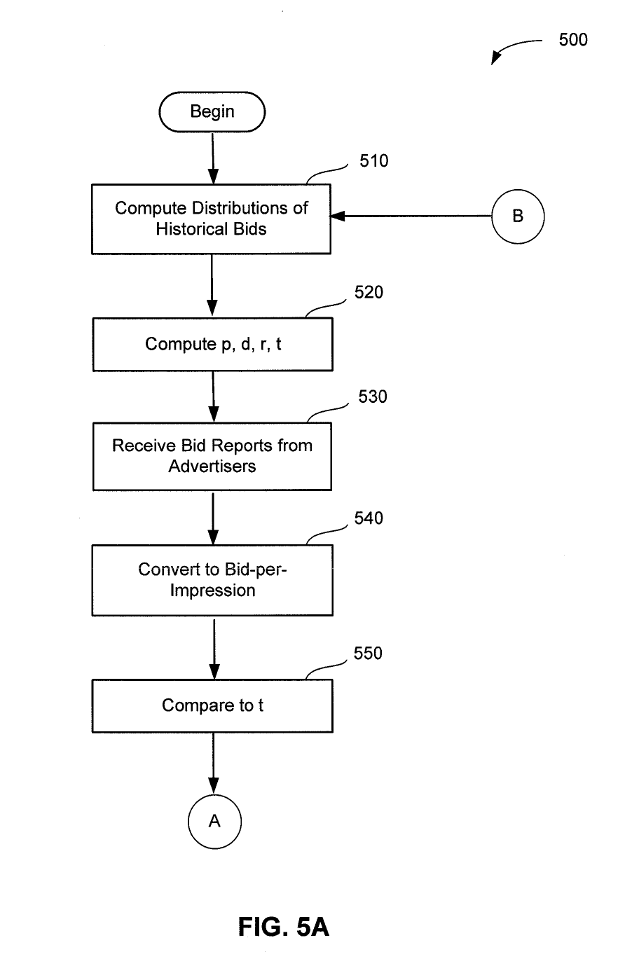

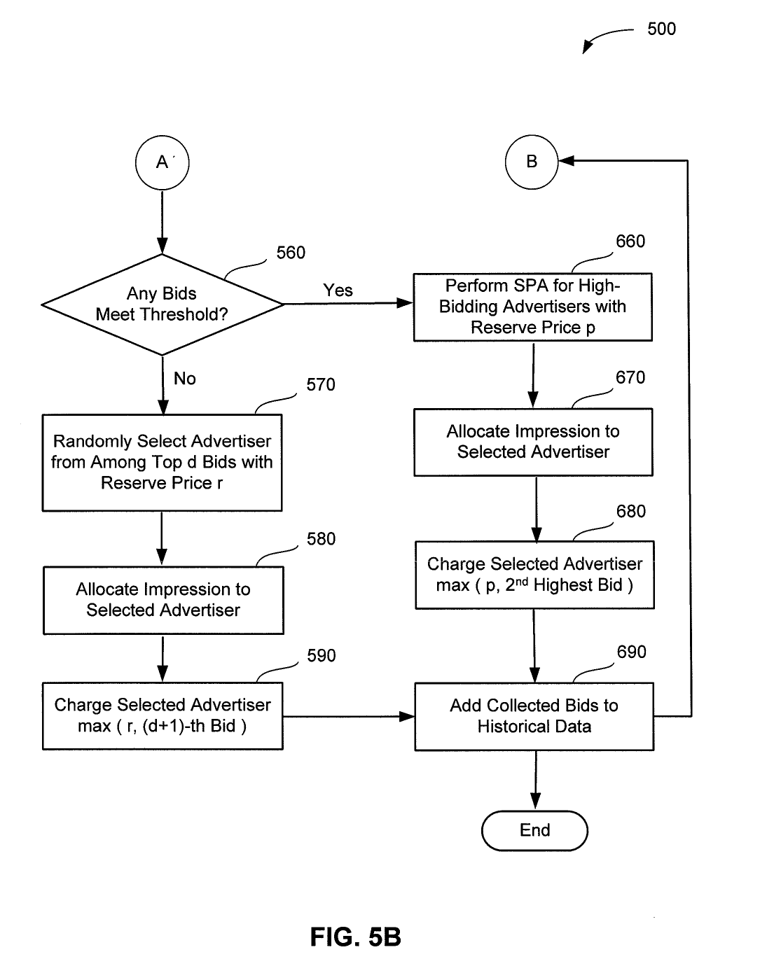

FIGS. 5A and 5B illustrate an exemplary method 500 for allocating an advertising impression in accordance with some embodiments of the present invention, illustrated in greater detail than in FIG. 4. Method 500 may represent, in some embodiments, an adaptation of a generic auction method such as method 400 to an automatic auction of an online advertising impression. Method 500 begins at act 510, at which an advertising platform may, through execution of program code by its one or more processors, compute distributions of historical bids F_{L} and F_{H}. At act 520, the advertising platform may, through processing by one or more processors, compute a priority price p for the priority auction, a number d of advertisers among which to randomize allocation in the secondary auction, a reserve price r for the secondary auction, and a threshold value t for automatically entering advertisers in the priority auction. Examples of suitable computations for deriving these values based on distributions of historical bids were given above.

At act 530, the advertising platform may receive a bid report from each advertiser participating in the auction. As described above, advertiser bid reports may be received in any of a variety of formats and representations, including per-impression bids, per-click bids and per-action bids. At act 540, the advertising platform may perform mathematical computations to convert one or more of the bids received from the advertisers' bid reports into equivalent per-impression bids to be used in allocating the advertising impression and determining a payment price for the winning advertiser, thus collecting an equivalent bid for each advertiser.

At act 550, one or more of the collected bids may be compared with the threshold value t to determine whether any of the bids meet or exceed t. If it is determined at act 560 that none of the collected bids meet the threshold value t, a winning advertiser may be selected randomly from among the advertisers with the top d bids. However, in some alternate embodiments as discussed above, a determination may be made as to whether any of the advertisers has separately elected the priority option, rather than comparing the advertisers' bids with a threshold value to automatically determine participation in the priority auction or the secondary randomized auction. In the secondary auction, if none of the bids meet or exceed the reserve price r, then in some embodiments the impression may not be allocated to any advertiser. In this case, in some embodiments, the advertising space in an unallocated impression may be filled with an advertisement or other content provided by the advertising platform itself, or may be left empty.

If a winning advertiser is successfully selected in the randomized secondary auction, however, the advertising impression may be allocated to that advertiser at act 580. At act 590, the winning advertiser may be charged a payment amount equal to the (d+1)-th highest bid. However, if the (d+1)-th bid is lower than the reserve price r, then the winning advertiser may be charged a payment amount equal to r.

If it is determined at act 560 that one or more of the collected bids meet or exceed the threshold value t, then a SPA priority auction may be performed at act 660 between only those advertisers whose bids meet or exceed t. At act 670, the impression may be allocated to the advertiser winning the priority auction, e.g., the advertiser with the highest bid. At act 680, in some embodiments the winning advertiser may be charged a payment amount equal to the priority price p, regardless of the amount of any other advertiser's bid. However, in other embodiments, as described above, the priority auction may be conducted as a SPA with a reserve price equal top, in which the winning advertiser may be charged the higher of the priority price p and the second-highest bid. In such embodiments, if more than one advertiser's bid is greater than or equal top, then the winning advertiser may be charged the second-highest bid. However, if no advertiser other than the winning advertiser has a bid greater than or equal top, then the winning advertiser may simply be charged p. At act 690, whether the advertising impression was allocated in the priority auction or the secondary auction, the bids collected for the auction may be added to the historical bid data used to compute distributions F_{L} and F_{H} for subsequent auctions.

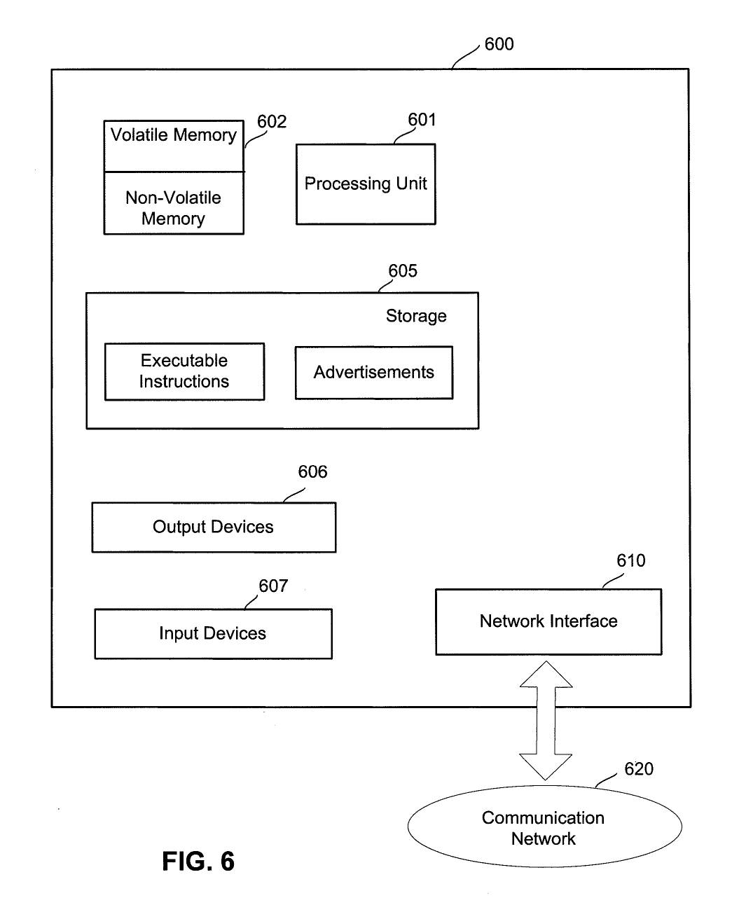

Various inventive aspects described herein may be used with any of one or more computers and/or devices each having one or more processors that may be programmed to take any of the actions described above for allocating advertising impressions. For example, advertising platforms, web servers, advertiser servers and user computing systems may be implemented as one or more computers, as described above. FIG. 6 shows, schematically, an illustrative computer 600 on which various inventive aspects of the present disclosure may be implemented. The computer 600 includes a processor or processing unit 601 and a memory 602 that may include volatile and/or non-volatile memory. The computer 600 may also include storage 605 (e.g., one or more disk drives) in addition to the system memory 602.

The memory 602 and/or storage 605 may store one or more computer-executable instructions to program the processing unit 601 to perform any of the functions described herein. The storage 605 may optionally also store one or more datasets as needed. For example, a computer used to implement web server 310 may in some embodiments store advertisements 350 in storage 605. Alternatively, such datasets may be implemented separately from a computer used to implement web server 310.

References herein to a computer can include any device having a programmed processor, including a rack-mounted computer, a desktop computer, a laptop computer, a tablet computer or any of numerous devices that may not generally be regarded as a computer, which include a programmed processor (e.g., a PDA, an MP3 Player, a mobile telephone, wireless headphones, etc.).

The exemplary computer 600 may have one or more input devices and/or output devices, such as devices 606 and 607 illustrated in FIG. 6. These devices may be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

As shown in FIG. 6, the computer 600 may also comprise one or more network interfaces (e.g., the network interface 610) to enable communication via various networks (e.g., the network 620). Examples of networks include a local area network or a wide area network, such as an enterprise network or the Internet. Such networks may be based on any suitable technology and may operate according to any suitable protocol and may include wireless networks, wired networks or fiber optic networks.

Having thus described several aspects of at least one embodiment of this invention, it is to be appreciated that various alterations, modifications, and improvements will readily occur to those skilled in the art. For instance, although examples have been provided of processing and data transmission mechanisms by which an auction may be implemented to allocate a single advertising space, it should be appreciated that such an auction may be implemented to concurrently allocate any number of advertising spaces. For example, multiple available advertising spaces on a webpage may be ranked in terms of their positioning, size, and/or any other relevant aspect or parameter. During allocation computations in a priority auction, for example, the one or more processors of an advertising platform may allocate the highest ranked advertising space to the advertiser with the highest bid, the next highest ranked advertising space to the advertiser with the next highest bid, and so on.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer readable storage medium or media can be transportable, such that the program or programs stored thereon can be loaded onto one or more different computers or other processors to implement various aspects of the present invention as discussed above. As used herein, the term “non-transitory computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. Apparatus comprising:
at least one network interface;
a memory storing processor-executable instructions; and
at least one processor operatively coupled to the at least one network interface and the memory, wherein upon execution of the processor-executable instructions, the at least one processor:
controls the at least one network interface to collect, for each of a plurality of bidders, a bid for at least one product and/or service, thereby collecting a plurality of bids;
determines whether to enter any of the plurality of bidders in a priority auction for the at least one product and/or service; and
if it is determined not to enter any of the plurality of bidders in the priority auction:
randomly selects a selected bidder from among a set of two or more bidders from among the plurality of bidders; and
allocates the at least one product and/or service to the selected bidder.

2. The apparatus of claim 1, wherein the at least one processor determines to enter a bidder in the priority auction if the bidder elects the priority auction.

3. The apparatus of claim 1, wherein the at least one processor determines to enter a bidder in the priority auction if the bidder's bid meets or exceeds a threshold value, wherein the at least one processor computes the threshold value based at least in part on a distribution of historical bids for products and/or services.

4. The apparatus of claim 1, wherein the at least one processor randomly selects the selected bidder such that selection of any bidder from among the set of bidders is equally likely.

5. The apparatus of claim 1, wherein the at least one processor further:
computes a number d;
ranks the plurality of bids; and
identifies d bidders having the d highest bids from among the ranked plurality of bids as the set of bidders from among which the selected bidder is randomly selected.

6. The apparatus of claim 5, wherein the at least one processor further controls the at least one network interface to request payment for the allocation from the selected bidder in the amount of the (d+1)-th highest bid from among the ranked plurality of bids.

7. The apparatus of claim 1, wherein the at least one processor further:
if it is determined to enter one or more bidders of the plurality of bidders in the priority auction:
performs a second-price auction to select a selected bidder from among the one or more bidders; and
allocates the at least one product and/or service to the selected bidder.

8. A method comprising:
collecting, for each of a plurality of advertisers, a bid for an advertising impression, thereby collecting a plurality of bids;
determining whether to enter any of the plurality of advertisers in a priority auction for the advertising impression; and
if it is determined not to enter any of the plurality of advertisers in the priority auction:
performing a computation via a computer to randomly select a selected advertiser from among a set of two or more advertisers from among the plurality of advertisers; and
with the computer, allocating the advertising impression to the selected advertiser.

9. The method of claim 8, wherein the allocating comprises displaying an advertisement designated by the selected advertiser on a webpage.

10. The method of claim 8, wherein it is determined to enter an advertiser in the priority auction if the advertiser elects the priority auction.

11. The method of claim 8, further comprising computing a threshold value based at least in part on a distribution of historical bids for advertising impressions, wherein it is determined to enter an advertiser in the priority auction if the advertiser's bid meets or exceeds the threshold value.

12. The method of claim 8, wherein performing the computation comprises:
determining a subset of the set of advertisers whose bids are above a reserve price; and
applying a uniform probability distribution to the subset of advertisers to select the selected advertiser.

13. The method of claim 8, further comprising:
computing a number d;
ranking the plurality of bids; and
identifying d advertisers having the d highest bids from among the ranked plurality of bids as the set of advertisers from among which the selected advertiser is randomly selected.

14. The method of claim 13, further comprising requesting payment for the allocation from the selected advertiser in the amount of the (d+1)-th highest bid from among the ranked plurality of bids, or in the amount of a reserve price, whichever is higher.

15. The method of claim 8, further comprising:
if it is determined to enter one or more advertisers of the plurality of advertisers in the priority auction:
performing a second-price auction via the computer to select a selected advertiser from among the one or more advertisers; and
with the computer, allocating the advertising impression to the selected advertiser.

16. At least one computer-readable storage medium encoded with a plurality of computer-executable instructions that, when executed, perform a method comprising:
collecting, for each of a plurality of advertisers, a bid for an advertising impression, thereby collecting a plurality of bids;
determining whether to enter any of the plurality of advertisers in a priority auction for the advertising impression; and
if it is determined not to enter any of the plurality of advertisers in the priority auction:
randomly selecting a selected advertiser from among a set of two or more advertisers from among the plurality of advertisers; and
allocating the advertising impression to the selected advertiser.

17. The at least one computer-readable storage medium of claim 16, wherein it is determined to enter an advertiser in the priority auction if the advertiser elects the priority auction.

18. The at least one computer-readable storage medium of claim 16, wherein the method further comprises computing a threshold value based at least in part on a distribution of historical bids for advertising impressions, wherein it is determined to enter an advertiser in the priority auction if the advertiser's bid meets or exceeds the threshold value.

19. The at least one computer-readable storage medium of claim 16, wherein the method further comprises:
computing a number d;
ranking the plurality of bids; and
identifying d advertisers having the d highest bids from among the ranked plurality of bids as the set of advertisers from among which the selected advertiser is randomly selected.

20. The at least one computer-readable storage medium of claim 16, wherein the method further comprises:
if it is determined to enter one or more advertisers of the plurality of advertisers in the priority auction:
performing a second-price auction to select a selected advertiser from among the one or more advertisers; and
allocating the advertising impression to the selected advertiser.
